(19) United States
(12) Patent Application Publication
(10) Pub. No.: US 2016/0268067 A1
(43) Pub. Date: Sep. 15, 2016

(54) SWITCHING DEVICE

(71) Applicant: OMRON Corporation, Kyoto-shi (JP)

(72) Inventors: Yuki YAMAMOTO, Okayama-shi (JP); Kazuyuki TSUKIMORI, Okayama-shi (JP); Makito MORII, Okayama-shi (JP); Yoshihiro UMEUCHI, Okayama-shi (JP)

(73) Assignee: OMRON Corporation, Kyoto-shi (JP)

(21) Appl. No.: 15/057,449

(22) Filed: Mar. 1, 2016

(30) Foreign Application Priority Data
Mar. 12, 2015 (JP) 2015-049766

(51) Int. Cl. H01H 3/16; H01H 1/023

(52) U.S. Cl. CPC H01H 3/16; H01H 1/023

(57) ABSTRACT

Provided is a switching device with both high durability and high contact reliability. The switching device includes a movable contact and a fixed contact mutually slide to switch a switching mechanism. In the switching device, on a surface of the fixed contact, a contact portion to come into contact with the movable contact is coated with hard plating having a Martens hardness of 132 mgf/μm² or more.

### CROSS-REFERENCE TO RELATED APPLICATION

This application is based on Japanese Patent Application No. 2015-049766 filed with the Japan Patent Office on Mar. 12, 2015, the entire contents of which are incorporated herein by reference.

### FIELD

The invention relates to a switching device, and for example, relates to a switching device provided with a sliding contact.

### BACKGROUND

A switching device is provided with contacts for switching on and off of a switching mechanism. The contacts are schematically classified into two types: “sliding contacts” and “opposed contacts”.

The sliding contacts and the opposed contacts are different in action when switching operation for switching on and off of the switching mechanism is performed. That is, in a case where the switching operation for turning off the switching mechanism is performed when the switching mechanism is on (namely, when two contacts are in contact with each other), one sliding contact slides while being in contact with the other sliding contact. Meanwhile, in the same case, one opposed contact moves in a direction away from the other opposed contact.

Since the opposed contacts and the sliding contacts are different in action when the switching operation is performed, those contacts are also different in durable number of times (durability) against the switching operation. Specifically, the durable number of times of the sliding contacts is approximately 300,000 to 1,000,000, for example. Meanwhile, the durable number of times of the opposed contacts is approximately tens of millions of times, for example. Therefore, the sliding contacts have been widely applied to switching devices for use in household electric appliances, automobiles and the like in which the number of times of actions by switching operation is small. Meanwhile, the opposed contacts have been applied to switching devices (e.g., limit switches) for industrial use in which the number of times of actions by switching operation is large.

JP 2007-326996 A describes one example of the sliding contacts. JP 2000-3636 A describes one example of the opposed contacts.

As compared to the opposed contacts, the sliding contacts have an advantage of having high contact reliability (low possibility to fail in coming into contact with the other opposed contact at the time of switching the switching mechanism from off to on). For this reason, the sliding contacts with higher reliability have been widely used in recent years. When the sliding contacts are adopted to the switching device for industrial use, malfunction of the switching device may hardly occur, the malfunction being caused by deterioration in ambient environment (generation of a corrosive gas, changes in temperature and humidity), contamination, or the like.

However, the contacts in the switching device for industrial use (e.g., a small signal device) are required to have high durability (large durable number of times) against the switching operation. Specifically, the contacts in the switching device for industrial use are required to have a durable number of times of approximately 10,000,000. Sliding contacts having such a large durable number of times have not existed so far. Hence, it is not possible to apply the conventional sliding contacts to the switching device for industrial use.

### SUMMARY

The invention has been made in view of the foregoing problem, and an object of the invention is to provide a switching device having both high durability and high contact reliability.

In order to solve the above problem, a switching device according to the invention is a switching device which includes a first contact and a second contact and in which the first contact slides while being in contact with a surface of the second contact in switching a switching mechanism. On the surface, at least a contact portion to come into contact with the first contact has a Martens hardness of 132 mgf/μm² or more.

According to the above configuration, since the contact portion on the surface of the second contact has a high Martens hardness, the second contact has high durability. Further, since the first contact and the second contact are sliding contacts that slide in switching the switching mechanism, there is a low possibility for occurrence of malfunction caused by a corrosive gas, contamination, or the like, and the contact reliability is high. Hence, it is possible to achieve both high durability and high contact reliability.

Further, in the switching device according to one aspect of the invention, on an outermost surface layer of the second contact, at least the contact portion to come into contact with the first contact may have a thickness from 1 μm or more to 10 μm or less.

According to the above configuration, formation of the outermost surface layer (at least the contact portion) of the second contact by use of a material having high hardness enables achievement of a Martens hardness of 132 mgf/μm² or more in the contact portion.

Further, in the switching device according to one aspect of the invention, the contact portion may contain, as a material, any of silver, gold, palladium, platinum, and an alloy thereof.

According to the above configuration, the contact portion contains, as the material, any of silver, gold, palladium, platinum, and an alloy thereof. Each of silver, gold, palladium, platinum, and an alloy thereof improves its hardness by being added with an additive. For example, silver improves its hardness by being added with a brightening agent containing Se (selenium) or Sb (antimony). Further, it is known that gold improves its hardness by being added with Ni (nickel) or Co (cobalt). Accordingly, by addition of an additive to the material at the time of processing of the contact portion, it is possible to achieve a Martens hardness of 132 mgf/μm² or more in the contact portion after the processing.

Further, in the switching device according to one aspect of the invention, the contact portion may have a Martens hardness of 300 mgf/μm² or less.

According to the above configuration, a true contact area between the first contact and the second contact does not become excessively small. Hence, it is possible to ensure sufficient electrical conductivity between the first contact and the second contact.

Further, in the switching device according to one aspect of the invention, the outermost surface layer of the contact portion may be formed using any of processing methods of plating, sputtering, vapor deposition, and bonding.

According to the above configuration, the outermost surface layer having a Martens hardness of 132 mgf/μm² or more can be formed using any of well-known processing methods of plating, sputtering, vapor deposition, and bonding.

According to the invention, it is possible to achieve both high durability and high contact reliability.

### BRIEF DESCRIPTION OF THE DRAWINGS

FIGS. 1A and 1B are perspective views showing a configuration of a switching device according to one embodiment;

FIGS. 2A and 2B are perspective views showing a configuration of the switching device according to one embodiment in a case where pressing force is applied to the switching device;

FIG. 3 is an enlarged view of a main part of the switching device shown in FIG. 2A; and

FIG. 4 is a diagram showing the correlation between a Martens hardness of a surface of a fixed contact, provided in the switching device according to one embodiment, and a thickness of the hard plating.

### DETAILED DESCRIPTION

Hereinafter, an embodiment of the invention will be described in detail.

### Configuration of Switching Device 1

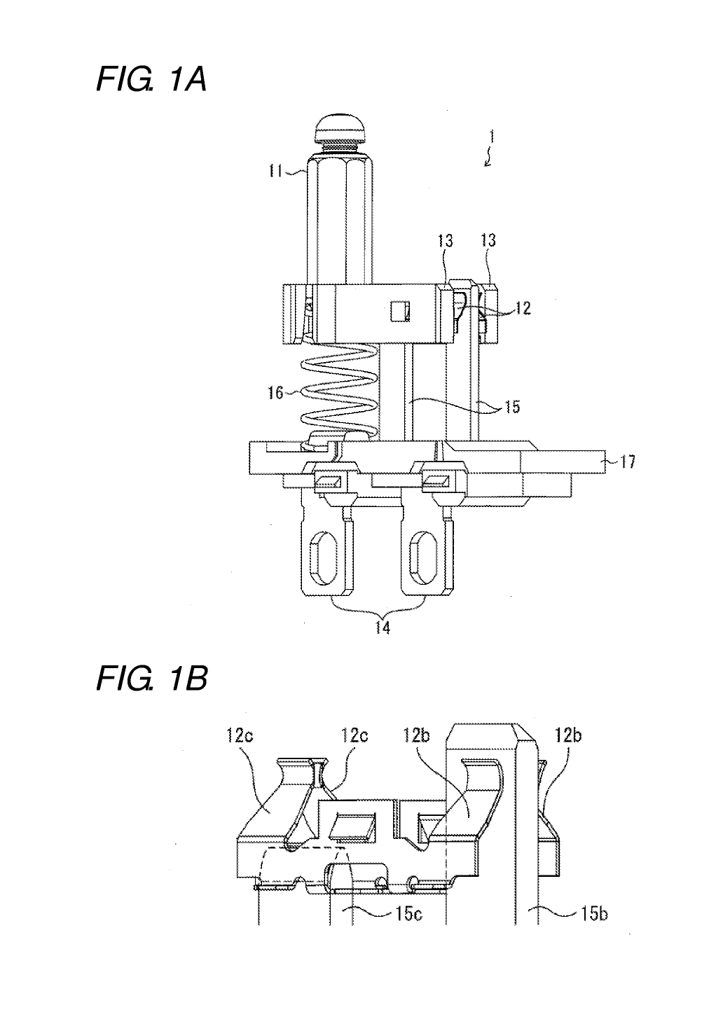

A configuration of a switching device 1 according to the embodiment will be described with reference to FIGS. 1A and 1B. FIG. 1A is a perspective view showing the configuration of the switching device 1. In practice, at least part of the switching device 1 is housed in a case, not shown. The switching device 1 is a switching device for industrial use, and is specifically a limit switch. The limit switch is used, for example, as a sensor for performing positioning or object detection in production equipment or an industrial machine.

As shown in FIG. 1A, the switching device 1 is provided with a first movable unit 11, a movable contact (first contact) 12, a second movable unit 13, a terminal 14, a fixed contact (second contact) 15, a spring 16, and a terminal base 17.

The first movable unit 11 is disposed on the spring 16. Further, the first movable unit 11 is integrally formed with the second movable unit 13. The first movable unit 11 and the second movable unit 13 are movable in a lengthwise direction of the figure.

The movable contact 12 is fixed to the second movable unit 13. The movable contact 12 constitutes a switching mechanism for switching an electrical contact state by sliding against a surface of the fixed contact 15.

FIG. 1B is a perspective view showing the movable contact 12 and the fixed contact 15 in an enlarged manner. As shown in FIG. 1B, the fixed contact 15 is made up of a first fixed contact 15b and a second fixed contact 15c. Further, the movable contact 12 includes a first movable contact portion 12b that slides against the first fixed contact 15b, and a second movable contact portion 12c that slides against the second fixed contact 15c.

When the second fixed contact 15c and the second movable contact portion 12c are in contact with each other, the switching mechanism is in an on-state. When the second fixed contact 15c and the second movable contact portion 12c are separated from each other, the switching mechanism is in an off-state. In the state shown in FIG. 1B, the second fixed contact 15c and the second movable contact portion 12c are separated from each other, and hence the switching mechanism is in the off-state.

The first fixed contact 15b and the first movable contact portion 12b are always in constant contact with each other irrespective of the position of the first movable unit 11. That is, the on or off switching of the switching mechanism is achieved by the contact or separation between the second fixed contact 15c and the second movable contact portion 12c.

The terminal 14 connects the switching device 1 to external electrical wiring. The terminal 14 is disposed on a lower surface of the terminal base 17.

The fixed contact 15 is disposed on an upper surface of the terminal base 17. That is, the fixed contact 15 is disposed on an opposite-side surface of the terminal base 17 to the surface thereof on which the terminal 14 is disposed.

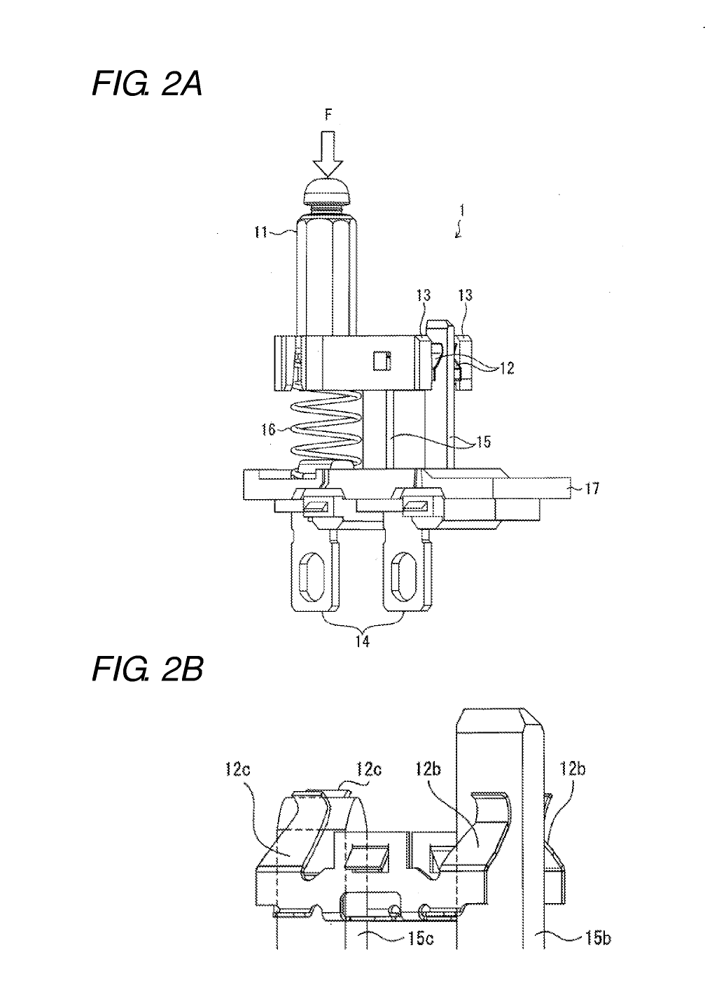

The spring 16 shrinks in the lengthwise direction by being applied with pressing force F (see FIG. 2A) downward from above. The spring 16 extends to its original length (its length before application of the pressing force F) by being released from the pressing force F. Similarly to the fixed contact 15, the spring 16 is disposed on the upper surface of the terminal base 17. The spring 16 is specifically a hook spring.

### Action of Switching Device 1

An action of the switching device 1 will be schematically described with reference to FIGS. 1A, 1B, 2A, and 2B. FIG. 2A shows a form of the switching device 1 in which the pressing force F is applied to the first movable unit 11, and FIG. 2B shows the movable contact 12 and the fixed contact 15 in an enlarged manner.

In a state where the pressing force F is not applied, as shown in FIGS. 1A and 1B, the second fixed contact 15c and the second movable contact portion 12c are separated from each other, and the switching mechanism is in the off-state.

As shown in FIG. 2A, when the pressing force F is applied to the first movable unit 11 and the second movable unit 13 downward from above, the pressing force F is applied to the spring 16 via the first movable unit 11. The spring 16 applied with the pressing force F shrinks in the lengthwise direction.

With the shrinkage of the spring 16 in the lengthwise direction, the first movable unit 11 disposed on the spring 16, the second movable unit 13 integrally formed with the first movable unit 11, and the movable contact 12 fixed to the second movable unit 13 move downward from above. Then, as shown in FIG. 2B, the second fixed contact 15c and the second movable contact portion 12c begin to come into contact with each other. Thus, the switching mechanism comes into the on-state. When the pressing force F is further applied, the second movable contact portion 12c further moves downward while the second movable contact portion 12c and the second fixed contact 15c rub against each other. During this time, the first movable contact portion 12b is held in the state of being always in constant contact with the first fixed contact 15b, while sliding against a surface of the first fixed contact 15b.

When the pressing force F of pressing the first movable unit 11 stops being applied (or is reduced), the first movable unit 11, the movable contact 12, and the second movable unit 13 return to original positions thereof (positions thereof before the application of the pressing force F to the first movable unit 11) by elastic force of the spring 16. Then, the second movable contact portion 12c moves upward while the second movable contact portion 12c and the second fixed contact 15c rub against each other, and is eventually separated from the second fixed contact 15c again. Thus, the switching mechanism comes back into the off-state.

The first movable unit 11 may not be configured to be movable in the lengthwise direction. For example, the first movable unit 11 may include an operation unit (e.g., a lever) that rotates and a slider that slides in the lengthwise direction in conjunction with rotation of the operation unit. In this configuration, when the operation of rotating the operation unit is performed, the first movable unit 11 converts, on the inside of the first movable unit 11, the force of rotating the operation unit to the force of moving the slider in the lengthwise direction. The movable contact 12 is fixed to the slider of the first movable unit 11. By rotation of the operation unit and sliding of the slider in the lengthwise direction, the movable contact 12 also moves in the lengthwise direction.

### Hard Plating Layer 15a

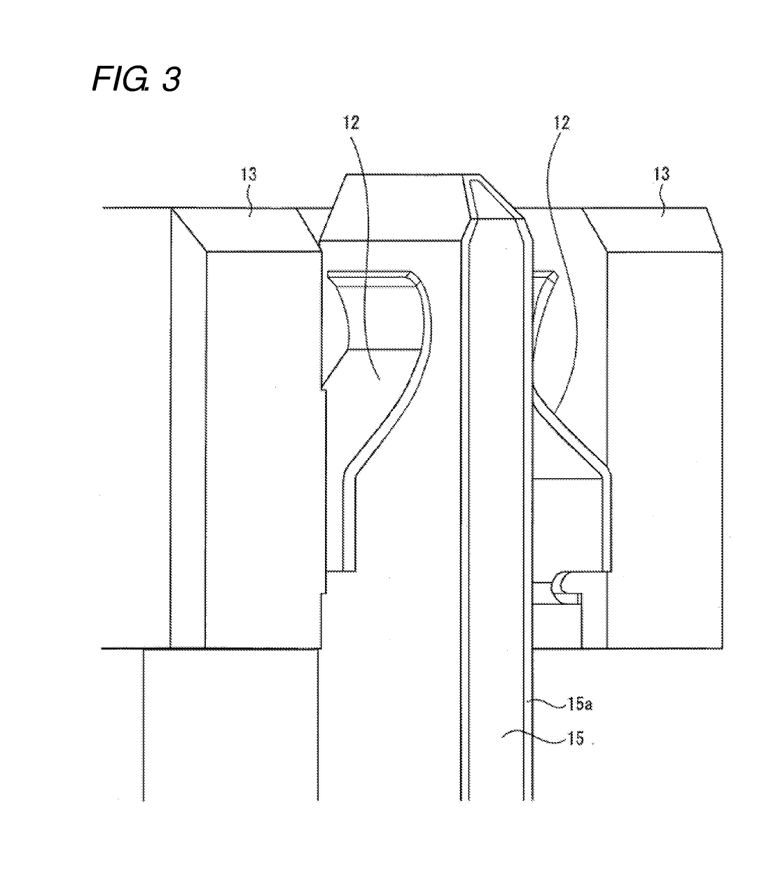

FIG. 3 is an enlarged view of a main part of the switching device 1 shown in FIG. 2A. As shown in FIG. 3, the fixed contact 15 is coated with a hard plating layer 15a (outermost surface layer). On the fixed contact 15, at least a contact portion to come into contact with the movable contact 12 may only be coated with the hard plating layer 15a.

The hard plating layer 15a desirably has a high Martens hardness of 132 mgf/μm² (HM) or more. However, a range of the desirable Martens hardness of the hard plating layer 15a relies on a material for the hard plating layer 15a. Further, a thickness of the hard plating layer 15a is preferably from 1 μm or more to 10 μm or less. However, the desirable thickness of the hard plating layer 15a relies on the material for the hard plating layer 15a (and the hardness of the material). For example, when the material for the hard plating layer 15a is Au or Pd, the thickness of the hard plating layer 15a is preferably 1 μm or more. When the material for the hard plating layer 15a is Ag, the thickness of the hard plating layer 15a is preferably 3 μm or more. This is because a friction characteristic of the hard plating layer 15a varies depending on the material, as will be described later. As will be described below, the Martens hardness and the thickness of the hard plating layer 15a are set such that the durable number of times of the fixed contact 15 is 10,000,000 or more (or at least 3,000,000 or more). The definition of the Martens hardness will be described later.

The material for the hard plating layer 15a may be a noble metal, for example. In particular, the material for the hard plating layer 15a is preferably Ag (silver), Au (gold), Pd (palladium), Pt (platinum), or an alloy thereof. In these configurations, the hard plating layer 15a may be formed using a processing method of electroplating or non-electroplating.

Alternatively, in one modification example, the fixed contact 15 may be coated with a surface layer, formed using a processing method of sputtering, vapor deposition, or lamination, in place of the hard plating layer 15a.

As described above, the fixed contact 15 is coated with the hard plating layer 15a having high a Martens hardness, and thus has a larger durable number of times than that of the conventional sliding contact. Further, the fixed contact 15 has a “true contact area” which is the minimum contact area required for electrical conduction with the movable contact 12. Hence, the fixed contact 15 also holds high contact reliability, similarly to the conventional sliding contact. Accordingly, the fixed contact 15 can achieve both high durability and high contact reliability.

The movable contact 12 is formed of a metal having a lower hardness than that of the hard plating layer 15a. That is, although abrasion occurs on the movable contact 12 due to sliding against the fixed contact 15, the movable contact 12 is kept by its elasticity in the state of being biased to and in contact with the fixed contact 15. Hence, the electrical connection between the movable contact 12 and the fixed contact 15 is held.

### Method for Setting Hardness and Thickness of Hard Plating Layer 15a

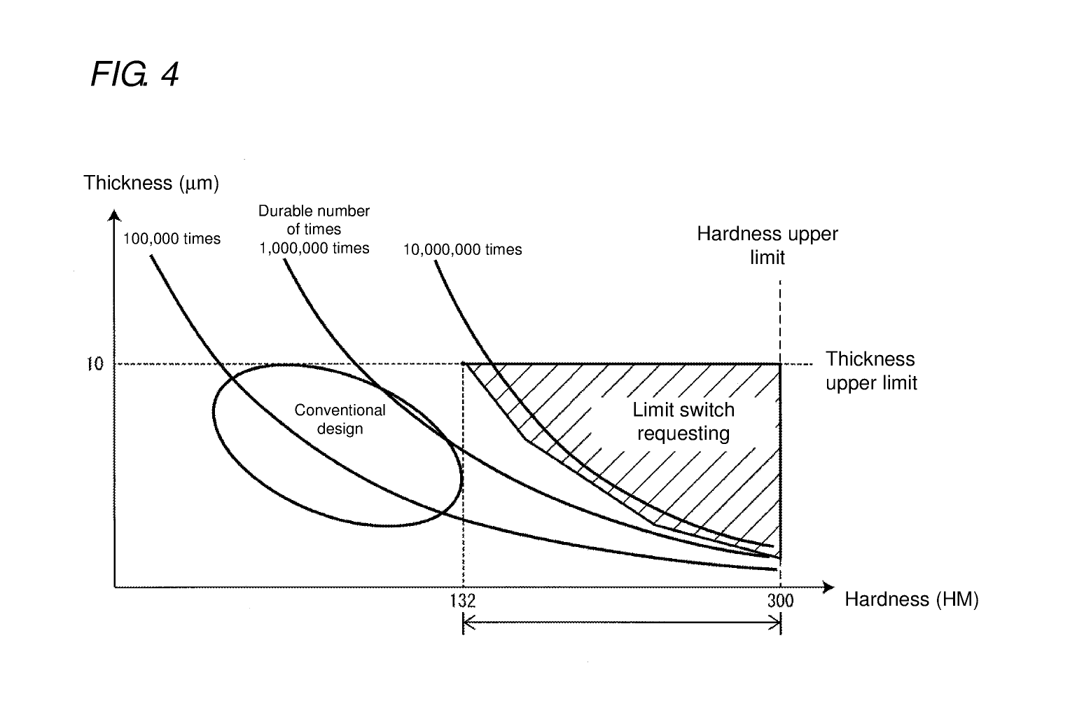

A method for setting the hardness and thickness of the hard plating layer 15a will be described with reference to FIG. 4. Herein, the material for the hard plating layer 15a is assumed to be Ag. FIG. 4 shows the correlation between a Martens hardness of the hard plating layer 15a made of Ag and a thickness of the hard plating layer 15a.

FIG. 4 shows a range of the Martens hardness and thickness of the hard plating layer 15a which are required by a limit switch for industrial use. Further, FIG. 4 also shows a range of a Martens hardness and thickness of the conventional sliding contact. In FIG. 4, a “hardness upper limit” value may be set to such a value as to make the contact area between the movable contact 12 and the fixed contact 15 not excessively small (as not to significantly impair the contact reliability). Specifically, the “hardness upper limit” value is preferably 300 mgf/μm² (HM). Further, a “thickness upper limit” value may be set in consideration of cost of the hard plating layer 15a. Since the material for the hard plating layer 15a is a noble metal, if the thickness is too large, the hard plating layer 15a would cost too high. Specifically, the “thickness upper limit” value is preferably 10 μm.

Further, FIG. 4 also shows a graph representing the respective lower limit values of the Martens hardness and thickness of the hard plating layer 15a, which are required for the fixed contact 15 to achieve a target value of the durable number of times.

As shown in FIG. 4, the limit switch for industrial use requires the durable number of times of the fixed contact 15 to be about 10,000,000 or more. The hardness and thickness of the hard plating layer 15a are set such that the durable number of times of the fixed contact 15 coated with the hard plating layer 15a becomes about 10,000,000 or more. Thus, the fixed contact 15 can be applied to the limit switch. On the other hand, as shown in FIG. 4, the durable number of times of the sliding contact according to the conventional design is about 1,000,000 or less. Thus, the conventional sliding contact cannot be applied to the limit switch.

As shown in FIG. 4, when the target value for the durable number of times of the fixed contact 15 is 10,000,000, and when the hardness of the hard plating layer 15a is 132 mgf/μm² (HM), the thickness of the hard plating layer 15a needs to be 10 μm (“thickness upper limit” value) or more. Conversely, for setting the thickness of the hard plating layer 15a to 10 μm or less, the Martens hardness of the hard plating layer 15a needs to be set to 132 mgf/μm² (HM) or more. Herein, the hardness and an abrasion loss of the hard plating layer 15a establish an inversely proportional relationship. For this reason, increasing the hardness of the hard plating layer 15a leads to improvement in durable number of times.

The required thickness changes in accordance with the material for the hard plating layer 15a. For example, when the material for the hard plating layer 15a is Au, the required thickness is about one-third of that in a case where the material for the hard plating layer 15a is Ag. This is because Ag and Au have different abrasion characteristics. The more easily (hardly) the material used for the hard plating layer 15a abrades, the larger (smaller) the thickness required for achieving the target value for the durable number of times of the fixed contact 15. The difference in abrasion characteristic depending on the material will be described later.

As will be seen from FIG. 4, when the target value for the durable number of times of the hard plating layer 15a is 1,000,000 and the Martens hardness of the hard plating layer 15a is 132 mgf/μm² (HM), the required thickness is smaller than 10 μm. Further, when the target value for the durable number of times of the fixed contact 15 is 100,000, the required thickness is even smaller. That is, the smaller (larger) the target value for the durable number of times, the smaller (larger) the required thickness. In other words, the smaller (larger) the target value for the durable number of times, the smaller (larger) the required Martens hardness. Difference in abrasion characteristic depending on material; description based on transfer phenomenon

It is generally thought that the abrasion characteristic of each hard plating layer 15a made of a material having the same hardness (an abrasion loss of each hard plating layer 15a in one action of the movable contact 12, or some other characteristic) is the same. However, in practice, the abrasion characteristic of the material for the hard plating layer 15a may vary depending on the material for the hard plating layer 15a. This is because behavior of an abrasion powder, fallen off the hard plating layer 15a due to abrasion, varies depending on the material for the hard plating layer 15a. Herein, as one example, a difference in abrasion characteristic between Ag and Au will be described.

As well known, Au is chemically highly stable. For this reason, when the material for the hard plating layer 15a is Au, a composition of the abrasion powder hardly changes from that of Au. Hence, the abrasion powder is easily transferred back onto the surface (sliding surface) of the hard plating layer 15a which rubs against the movable contact 12. Additionally, the abrasion powder of Au acts like a cushion between the hard plating layer 15a and the movable contact 12, thereby suppressing the progress of abrasion of the hard plating layer 15a.

Accordingly, the hard plating layer 15a made of Au has the characteristic of hardly abrading. As a result, the durability of the fixed contact 15 coated with the hard plating layer 15a made of Au becomes high.

Meanwhile, Ag corrodes by an effect of oxidation, sulfurization, or the like. Thus, when the material for the hard plating layer 15a is Ag, the composition of the abrasion powder transforms by the effect of oxidation, sulfurization, or the like. Further, grease molecules applied onto the sliding surface are easily adsorbed to the abrasion powder of Ag, as compared to the abrasion powder of Au. This makes the abrasion powder hardly transferred back onto the sliding surface. Further, the abrasion powder of Ag acts like an abrasive between the movable contact 12 and the hard plating layer 15a with which the fixed contact 15 is coated, to promote abrasion of the hard plating layer 15a.

Accordingly, the hard plating layer 15a made of Ag has the characteristic of easily abrading. As a result, the durability of the fixed contact 15 coated with the hard plating layer 15a made of Ag becomes relatively low.

As described above, when the material for the hard plating layer 15a is Au, the material can improve the durability of the fixed contact 15 as compared to the case in which the material for the hard plating layer 15a is Ag. In other words, when the material for the hard plating layer 15a is Au, the material can provide the durability (durable number of times) equivalent to that of the fixed contact 15 by having a small thickness, as compared to the case in which the material for the hard plating layer 15a is Ag.

### Martens Hardness

The Martens hardness is defined as the quotient <FMAX>/<A(h)> obtained by dividing the maximum value <FMAX> of test force, applied to the surface of a sample by an indenter, by a surface area <A(h)> of a depression formed on the surface of the sample by the test force. Herein, the surface area <A(h)> of the depression is calculated from a depth <h> of the indenter pressed into the sample.

There exist two types of indenters, which are a Vickers indenter and a Berkovich indenter. The shape, size, and the like of the contact surface between the indenter and the sample vary depending on the type of the indenter, and a calculation formula for the surface area <A(h)> of the depression also varies. However, the basic definition of the Martens hardness is as described above, irrespective of the type of the indenter.

### Modification Example

In the embodiment, the configuration has been described where the hard plating layer 15a with which the fixed contact 15 is coated has the Martens hardness of 132 mgf/μm² or more. However, in the invention, the “surface” of the fixed contact 15 may only have a high hardness of 132 mgf/μm² or more. The “surface” of the fixed contact 15 means the surface on which the fixed contact 15 is in contact with the movable contact 12. Specifically, when the fixed contact 15 is coated (by plating or the like), the “surface” of the fixed contact 15 is the surface of the coating layer (the surface of the outermost surface layer when a plurality of coating layers are laminated). Meanwhile, when the fixed contact 15 is not coated, the “surface” of the fixed contact 15 is the surface of the fixed contact 15. Accordingly, the surface of the fixed contact 15 is not required to be coated with the coating layer or the like so long as the fixed contact 15 has a hardness of 132 mgf/μm² or more.

For example, in one modification example, the fixed contact 15 may be formed of the same material (e.g., Au, Ag, Pd, Pt) as that for the hard plating layer 15a, and the surface of the fixed contact 15 may have a Martens hardness of 132 mgf/μm² or more. According to this modification example, there is an advantage in that plating for coating the fixed contact 15 with the hard plating layer 15a is unnecessary.

The invention is not restricted to the foregoing embodiment, and a variety of modifications can be made in the scope of the claims.

The invention can be applied to a switching device for industrial use, such as a limit switch.

1. A switching device comprising a first contact and a second contact, the first contact sliding while being in contact with a surface of the second contact in switching a switching mechanism,
wherein
on the surface, at least a contact portion to come into contact with the first contact has a Martens hardness of 132 mgf/μm² or more.

2. The switching device according to claim 1, wherein, on an outermost surface layer of the second contact, at least the contact portion to come into contact with the first contact has a thickness from 1 μm or more to 10 μm or less.

3. The switching device according to claim 1, wherein the contact portion contains, as a material, any of silver, gold, palladium, platinum, and an alloy thereof.

4. The switching device according to claim 1, wherein the contact portion has a Martens hardness of 300 mgf/μm² or less.

5. The switching device according to claim 2, wherein the outermost surface layer of the contact portion is formed using any of processing methods of plating, sputtering, vapor deposition, and bonding.
